(19) United States
(12) Patent Application Publication
(10) Pub. No.: US 2004/0181417 A1
(43) Pub. Date: Sep. 16, 2004

(54) Managing the definition of a product innovation

(76) Inventors: Gunther Piller, Walldorf (DE); Yvonne Goetzmann, St. Leon-Rot (DE); Rituparna Sengupta, Walldorf (DE); Joerg Beringer, Frankfurt (DE); Michael Hatscher, Osnabrueck (DE)

Correspondence Address: FISH & RICHARDSON, P.C., 3300 DAIN RAUSCHER PLAZA, 60 SOUTH SIXTH STREET, MINNEAPOLIS, MN, 55402, US

(21) Appl. No.: 10/389,234

(22) Filed: Mar. 14, 2003

(51) Int. Cl. G06F 17/60

(52) U.S. Cl. 705/1; 705/28

(57) ABSTRACT

Systems and techniques to facilitate collaborative development of product definitions allow convenient and efficient identification and evaluation of product innovation ideas. In general, in one implementation, the technique includes receiving product innovation ideas via a network and storing the product innovation ideas. The stored product innovation ideas are displayed for review by a user, and the user may send an indication via the network of one or more selected product innovation ideas. Web-based collaboration among an evaluation team comprising a plurality of members provides a mechanism for evaluating the at least one user-selected product innovation idea.

### BACKGROUND

This description relates to organizing and presenting data for a business enterprise, and more particularly to managing the development and definition of a product concept and design.

Various techniques exist for presenting and reviewing data generally. Such techniques include presenting data in a spider chart and presenting different types of data side-by-side for comparison. In the field of enterprise management, presenting business data in a simple yet comprehensive manner can be very important to executive decision making. Thus, effective methods of data presentation are valuable.

Presenting data for effective and efficient analysis is important, for example, in evaluating new product ideas. On average, only one successful new product results from every sixty product ideas, and over the last decade new product introduction success rates have dropped from about 75 percent to about 25 percent. Moreover, even relatively short delays in new product introductions can significantly reduce total profit. Therefore, efficient and effective analysis of new product ideas can be important.

### SUMMARY

The present application teaches systems and techniques for managing the collection, review, and evaluation of product innovation ideas by providing for the consolidation of product innovation management services in an application that uses information and services available in an enterprise's existing systems. The present inventors recognized that the conventional development of product innovations tends to be inefficient and frequently ineffective at identifying ideas and concepts that ultimately result in successful products. Accordingly, the inventors developed product innovation management systems and techniques that, among other things, streamline the product innovation process by providing for consolidated management of product innovation idea submission, review, evaluation, and development and by providing the appropriate personnel with convenient access to relevant information during the process of defining a product innovation.

In one aspect, a method for facilitating collaborative development of product definitions includes receiving product innovation ideas via a network and storing the product innovation ideas. The stored product innovation ideas are displayed for review by a user, and the user can submit an indication of selected product innovation ideas via the network. Web-based collaboration among evaluation team members then allows for evaluating the user-selected product innovation ideas.

Implementations may include one or more of the following features. For example, information for setting up a business case study relating to the user-selected product innovation ideas may be displayed. Data relating to assigned tasks for the business case study may then be received via the network, and access may be provided via the network to the data relating to the assigned tasks. Similarly, information for conducting a feasibility study relating to the user-selected product innovation ideas may be displayed. Data relating to a previously developed product corresponding to the product innovation idea may also be retrieved, with the data relating to the previously developed product being retrieved from a product management system, and the information for conducting the feasibility study may be updated based on the retrieved data. The evaluation team may evaluate the user-selected product innovation ideas after performing at least one of a business case study and a feasibility study.

Implementations may also include receiving evaluation information from at least one of the members of the evaluation team, storing the evaluation information, and providing access to the stored evaluation information to other members of the evaluation team. Data for modifying the user-selected product innovation ideas may be received from the user based on the evaluation information. The user may also modify one or more of the product innovation ideas, search for similar ideas, and consolidate a selected collection of ideas into a single idea. A list of suggested members for the evaluation team may be automatically generated based on a correspondence between data associated with a user-selected idea and data from a human resources system. Product portfolio performance data and/or product market data, from which the user can identify products that may benefit from a product innovation, may be displayed to the user, and information may be received from the user for soliciting product innovation ideas via the network, with the received product innovation ideas being responsive to the information for soliciting product innovation ideas.

In another general aspect, a product innovation management system includes a computer system, a product innovation consolidation system stored within the computer system and accessible via a network, and a plurality of clients operable to access the product innovation consolidation system via the network. The product innovation consolidation system includes a business object layer that is operable to maintain objects relating to a product innovation management process, an application services layer including logic for controlling the product innovation management process, and a database for storing product innovation idea data defining instances of the objects. The product innovation consolidation system is operable to allow a client user to view product innovation ideas, select product innovation ideas, and initiate a collaborative evaluation of selected product innovation ideas.

Implementations may include one or more of the following features. For example, the system may include knowledge management tools for supporting the product innovation management process. The knowledge management tools provide document services, collaboration services, search and retrieval services, and/or workflow services. The system of claim may include an interface to one or more base systems from which the product innovation consolidation system can retrieve data relating to products, financials, projects, resources, customers, suppliers, schedules, and/or individuals. The product innovation consolidation system further may include an access layer for coordinating access between the application services layer, the knowledge management tools, and the base systems. The client user may access the product management consolidation system to view at least one of performance data for a product portfolio and product market data and to solicit product innovation ideas from other client users. The client user may access the product management consolidation system to identify an evaluation team comprising a plurality of members. The evaluation team members may be automatically generated by the product management consolidation system based on a correspondence between parameters of a selected product innovation idea and a skill set of each evaluation team member. The evaluation team members may access the product innovation consolidation system to provide feedback relating to at least one selected product innovation idea.

In yet another general aspect, a machine-readable medium stores instructions operable to cause one or more machines to perform operations including receiving product innovation ideas, displaying received product innovation ideas to a user, receiving a selection from the user of one or more product innovation ideas to generate a product concept, providing information relating to the product concept to evaluation team members, receiving feedback relating to the product concept from the evaluation team members, and displaying the feedback to the user.

Implementations may include one or more of the following features. For example, the machine-readable medium may include instructions operable to cause one or more machines to receive data for modifying the product concept. The feedback may include requirements for the product concept, features of the product concept, comments on the product concept, and/or ratings of the product concept. The machine-readable medium may include instructions operable to cause one or more machines to display product innovation ideas that relate to the product concept, receive a selection of one or more of the displayed product innovation ideas that relate to the product concept, and combine the selected product innovation ideas into the product concept. The machine-readable medium may include instructions operable to cause one or more machines to maintain status information for an evaluation performed by the evaluation team.

Details of one or more implementations are set forth in the accompanying drawings and the description below. Other features and advantages may be apparent from the description and drawings, and from the claims.

### BRIEF DESCRIPTION OF THE DRAWINGS

These and other aspects will now be described in detail with reference to the following drawings.

FIG. 1 shows a block diagram of a data processing system.

FIG. 2 is a block diagram illustrating an example integrated business management system that can be implemented in the data processing system of FIG. 1.

FIG. 3 is a flow diagram illustrating a product innovation process for screening and refining a new product idea to define a new product.

FIG. 4 is a block diagram illustrating components of an example integrated product innovation management system.

FIG. 5 is an example view created by an integrated product innovation management system.

FIG. 6 is an example view that is displayed when the PDA element of FIG. 5 is selected.

FIG. 7 is an example idea submission view created by the integrated product innovation management system.

FIG. 8 is an example view of an innovation management overview.

FIG. 9 is another example view of an innovation management overview.

FIG. 10 is an example ideas view generated by the integrated product innovation management system.

FIG. 11 is another example ideas view generated by the integrated product innovation management system.

FIG. 12 is an example concept view generated by the integrated product innovation management system.

FIG. 13 is an example view of ideas attached to a concept generated by the integrated product innovation management system.

FIG. 14 is an example concept list view that includes a list of concept objects in the integrated product innovation management system.

FIG. 15 is an example evaluation setup view generated by the integrated product innovation management system.

FIG. 16 is an example innovation talk setup view generated by the integrated product innovation management system.

FIG. 17 is an example evaluation status view generated by the integrated product innovation management system.

FIG. 18 is an example business case study view generated by the integrated product innovation management system.

FIG. 19 is an example feasibility study view generated by the integrated product innovation management system.

FIG. 20 is an example evaluation status view generated by the integrated product innovation management system.

FIG. 21 is an example plus/minus voting evaluation view generated by the integrated product innovation management system.

FIG. 22 is a flow diagram illustrating a concept generation process.

FIG. 23 is a flow diagram illustrating a product definition process.

Like reference symbols in the various drawings indicate like elements.

### DETAILED DESCRIPTION

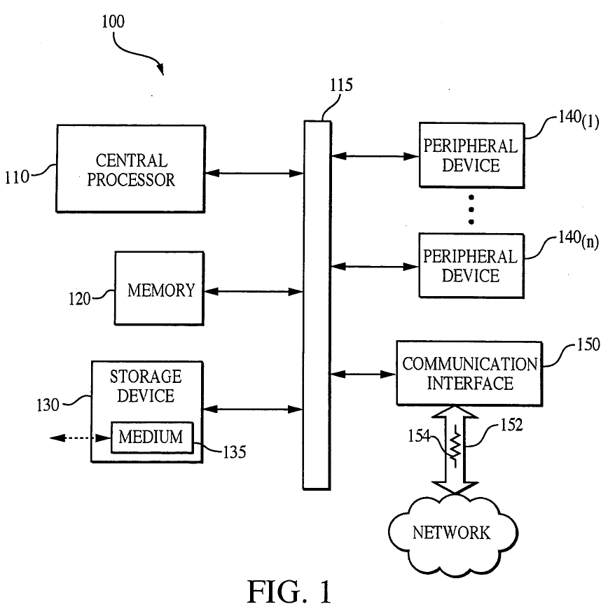

FIG. 1 is a block diagram illustrating an example data processing system 100. The data processing system 100 includes a central processor 110, which executes programs, performs data manipulations and controls tasks in the system 100. The central processor 110 is coupled with a bus 115 that can include multiple busses, which may be parallel and/or serial busses.

The data processing system 100 includes a memory 120, which can be volatile and/or non-volatile memory, and is coupled with the communications bus 115. The system 100 can also include one or more cache memories. The data processing system 100 can include a storage device 130 for accessing a storage medium 135, which may be removable, read-only, or read/write media and may be magnetic-based, optical-based, semiconductor-based media, or a combination of these. The data processing system 100 can also include one or more peripheral devices 140(1)-140(n) (collectively, devices 140), and one or more controllers and/or adapters for providing interface functions.

The system 100 can further include a communication interface 150, which allows software and data to be transferred, in the form of signals 154 over a channel 152, between the system 100 and external devices, networks or information sources. The signals 154 can embody instructions for causing the system 100 to perform operations. The system 100 represents a programmable machine, and can include various devices such as embedded controllers, Programmable Logic Devices (PLDs), Application Specific Integrated Circuits (ASICs), and the like. Machine instructions (also known as programs, software, software applications or code) can be stored in the machine 100 and/or delivered to the machine 100 over a communication interface. These instructions, when executed, enable the machine 100 to perform the features and function described above. These instructions represent controllers of the machine 100 and can be implemented in a high-level procedural and/or object-oriented programming language, and/or in assembly/machine language. Such languages can be compiled and/or interpreted languages.

As used herein, the term “machine-readable medium” refers to any computer program product, apparatus and/or device used to provide machine instructions and/or data to the machine 100, including a machine-readable medium that receives machine instructions as a machine-readable signal. Examples of a machine-readable medium include the storage medium 135, the memory 120, and/or PLDs, FPGAs, ASICs, and the like. The term “machine-readable signal” refers to any signal, such as the signals 154, used to provide machine instructions and/or data to the machine 100.

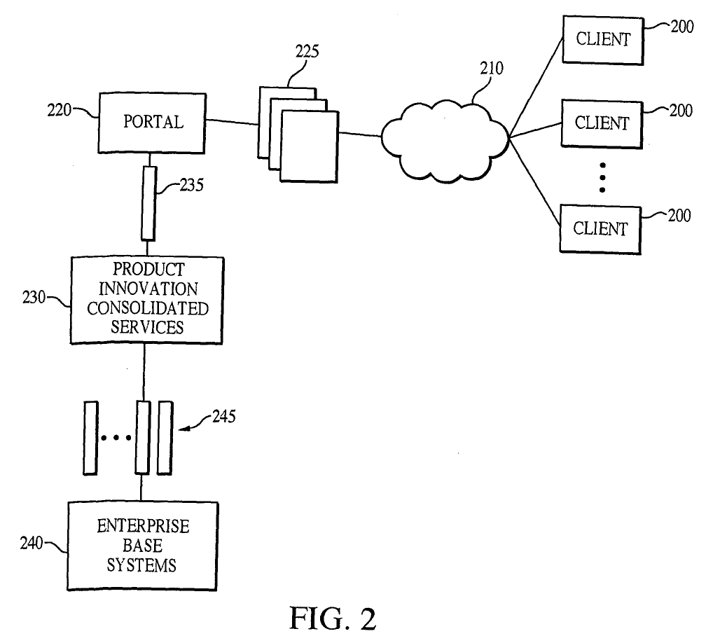

FIG. 2 is a block diagram illustrating an example integrated business management system that can be implemented in the data processing system 100 of FIG. 1. Multiple clients 200 can access data over a network 210 through a portal 220. The network 210 can be any communication network linking machines capable of communicating using one or more networking protocols. The network 210 can be a local area network (LAN), metropolitan area network (MAN), wide area network (WAN), enterprise network, virtual private network (VPN), the Internet, and the like. The clients 200 can be any machines or processes capable of communicating over the network 210. The clients 200 can be Web Browsers and can be communicatively coupled with the network 210 through a proxy server.

The portal 220 provides a common interface to program management services. The portal 220 receives requests from the clients 200 and generates data views 225 (e.g., Web pages) in response. The portal 220 can implement a user roles-based system to personalize the common interface and the data views 225 for a user of a client 200. A user has one or more associated roles that allow personalized tailoring of a presented interface through the generated data views 225.

The portal 220 communicates with a product innovation consolidation system 230 that consolidates multiple application services. The portal 220 receives data 235 from the product innovation consolidation system 230 for use in fulfilling the requests from the clients 200. The product innovation consolidation system 230 provides integrated application services to manage business objects in a business enterprise. The business objects can be resources (e.g., human resources), development projects, business programs, inventories, clients, accounts, business products, business services, and/or product or service attributes.

The product innovation consolidation system 230 communicates with enterprise base systems 240 to obtain multiple types of data 245. The enterprise base systems 240 can include various existing application services, such as human resource management systems, financial management systems, project management systems, time management systems, and electronic file and/or mail systems. The product innovation consolidation system 230 can consolidate and integrate the data and functionality of such systems into a single business management tool.

The portal 220, product innovation consolidation system 230 and enterprise base systems 240 can reside in one or more programmable machines, which can communicate over a network or one or more communication busses. For example, the base systems 240 can reside in multiple servers connected to an enterprise network, and the portal 220 and the product innovation consolidation system 230 can reside in a server connected to a public network. Thus, a user of the system can access and manage business programs and resources through a single portal from anywhere that access to a public network is available.

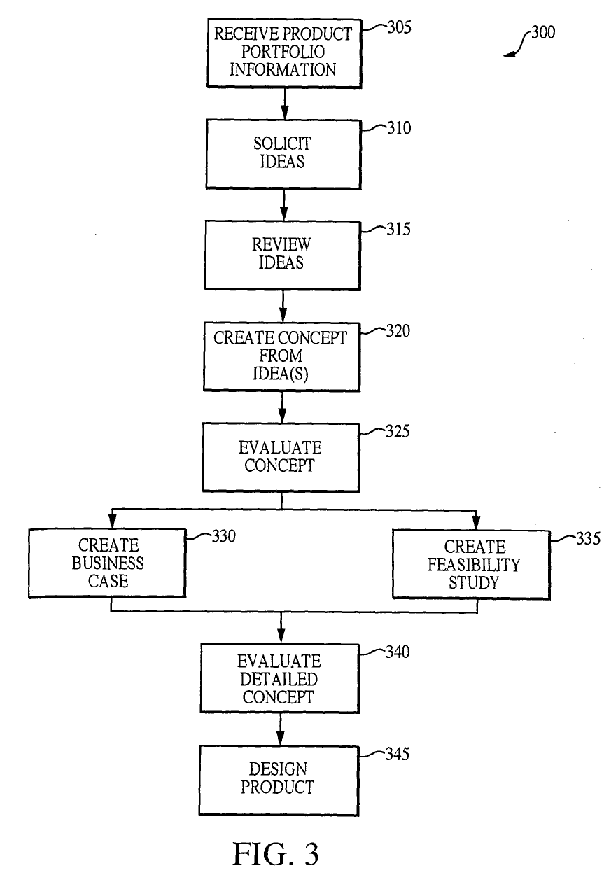

FIG. 3 is a flow diagram illustrating a product innovation process 300 for screening and refining a new product idea to define a new product. Information describing product portfolio performance for a business enterprise is received (step 305). This information can relate, for example, to sales growth, market share, market growth, or other data from which the performance of a product can be evaluated or from which the potential success of a new type of product may be assessed. The product portfolio performance information may be presented as a chart or graph for ease of interpretation.

Based on an analysis of the product portfolio performance information, or based on some other influence or motivation, a product innovation manager can identify product areas that might benefit from some type of innovation. Accordingly, the product innovation manager can solicit ideas from sales, service, development, and/or marketing colleagues internal or external to the business enterprise (step 310). After one or more ideas are submitted, the product innovation manager can review the ideas to determine whether any of the ideas appear promising (step 315). The ideas can be modified or combined to create a concept (step 320).

Once a concept is created, a team can be assigned to evaluate the concept (step 325). The team members for the evaluation can be selected based on a matching of employee skill set data stored in the human resources system with keywords that characterize the concept. Alternatively or in addition, team members can be assigned randomly or selected by the innovation manager. The evaluation process can involve an online chat room or email-type discussion; scheduling a conference call; numerical, plus/minus, or graphical ratings; establishing a task force; or some type of voting.

Assuming the outcome of the evaluation is positive, a team can be assigned to create a business case (step 330). The purpose of the business case is, for example, to generate a revenue estimate and to define the product features (e.g., what features must the product have to support certain target customer segments). Team members for the business case may be assigned particular tasks with associated deadlines. The assigned tasks may be selected based on each employee's skill sets. In addition, a team can be assigned to create a feasibility study (step 335). The feasibility study analyzes the technical feasibility of the concept (i.e., can it be done?), identifies how much resources will implementation of the concept consume, and determines how much will the implementation cost.

Once the business case and feasibility study are completed, another or the same evaluation team can be assigned to evaluate the detailed product concept (step 340). Assuming the outcome of the detailed evaluation is positive, the process can proceed to product design (step 345).

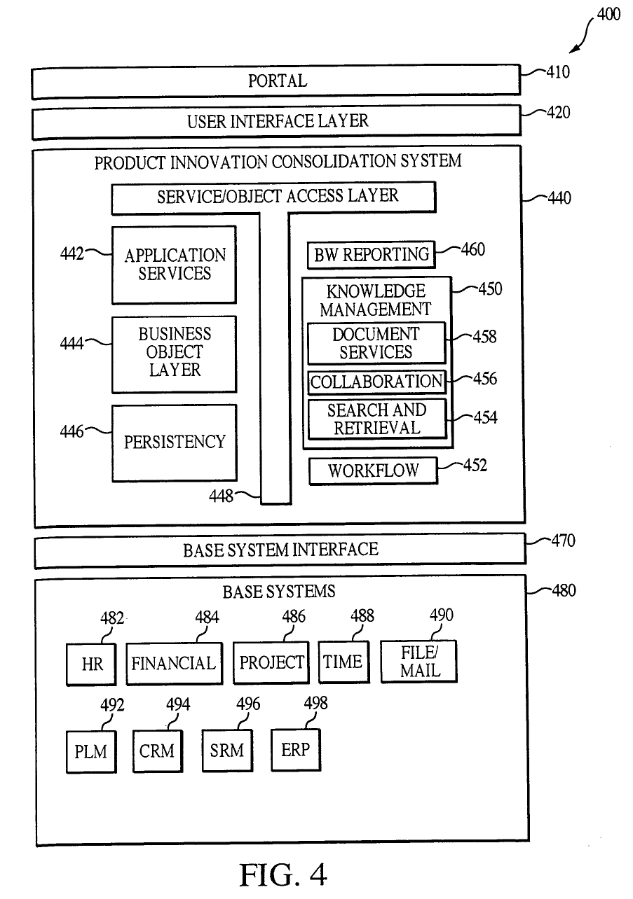

FIG. 4 is a block diagram illustrating components of an example integrated product innovation management system 400. The system 400 includes a portal 410, a user interface layer 420, a product innovation consolidation system 440, and base systems 480. The base systems 480 include a human resources (HR) system 482, a financial management system 484, a project management system 486, a time management system 488, a file/mail system 490, a product lifecycle management (PLM) system 492, a customer relationship management (CRM) system 494, a supplier relationship management (SRM) system 496, and an enterprise resource planning (ERP) system 498. The HR system 482 can store and track employee master data and organizational data, employee availability data, and employee skills data. The financial management system 484 can store and track project costs using project master data, accounts data and budget data.

The financial management system 484 can be integrated with the project management system 486, which can store and track project master data, organizational data, scheduling, location and quality, and required skills data. The time management system 488 can store and track time worked data on an employee and project basis. The mail/file system 490 can be a networked electronic mail system and electronic file system. The product lifecycle management system 492 can store specifications, bills of materials, routing and resource data, project structures, and related technical documentation throughout a product life cycle. The customer relationship management system 494 stores customer billing and order data. The supplier relationship management system 496 stores data relating to sourcing costs, volumes, turnaround times, and goods, materials, and services provided. The enterprise resource planning system 498 stores information regarding resource availability, employee skill sets, and cost data.

The product innovation consolidation system 440 includes an application services layer 442, a business object layer 444, a persistency database 446, and a service/object access layer 448. The application services layer 442 contains the logic of the product innovation application itself (e.g., how to consolidate ideas). The application services layer 442 stores generic application services that encapsulate application logic and that can be used to customize the integrated product innovation management system 400 to the needs of the enterprise. Web services can also be integrated, and product innovation application services can be used as web services.

The business object layer 444 defines the objects that can be used by the product innovation consolidation system 440. For example, these objects can include concepts, products, attributes, product development roles, product features, assigned tasks, skills, persons, and schedules. The business object layer 444 provides a central repository for all available business objects. For each of the business objects, a set of standard services is implemented in the application services layer 442 that enables use of the business object. Metadata about the objects is stored and enables generic services, such as automatic generation of default user interfaces, object access interfaces, data access methods, persistency, and mappings.

The persistency database 446 is a database where application information (e.g., database tables for ideas, concepts, and features) is stored. The information in the persistency database can include data defining instances of objects stored in the business object layer 444.

The service/object access layer 448 operates to facilitate access between the application services layer 442, the business object layer 444, and the persistency layer 446 and other resources, tools, or systems. The service/object access layer 448 allows the product innovation consolidation system 440 to be implemented as a homogenous application via a unified access to/from the objects and the services.

The persistency database 446 and the business object layer 444 provide a consolidated knowledge base to support multiple product innovation functions, such as product portfolio analysis, innovation management, concept management, product evaluation, scheduling, workforce planning (e.g., staffing resource assignment and hiring), and skills management. Active communication between the persistency database 446, the business object layer 444, and the base systems 480 provides a tight linkage between real-time operational data from multiple base systems and an integrated concept analysis tool to allow strategic product innovation management and planning.

The product innovation consolidation system 440 interfaces with the base systems 480 through a base system interface 470 that enables data exchange and integration with the base systems 480. The product innovation consolidation system 440 is decoupled from the underlying base systems 480 by the base system interface 470, which defines inbound and outbound interfaces to the product innovation consolidation system 440. The base system interface 470 includes information on how to connect to the various base systems 480 and data on how data is mapped and routed between the base systems 480 and the product innovation consolidation system 440.

The application services layer 442 coordinates the activities of a set of knowledge management tools 450, a workflow tool 452, and a business warehouse reporting engine 460 and their respective interactions with the portal 410. The knowledge management tools 450 can include a search and retrieval engine 454, a collaboration tool 456, and a document services tool 458. The workflow tool 452 allows users (e.g., product innovation managers) to define the order in which an assignment or project is passed between teams or individual team members. The search and retrieval engine 454 allows users to search for, e.g., documents or objects by keywords. The collaboration tool 456 provides a workspace for teams to work together by providing generic knowledge management functions, such as subscription services, feedback, rating, and time-based publishing. The document services tool 458 allows users to retrieve unstructured data. Finally, the business warehouse reporting engine 460 defines methods of extracting data for use in reporting and analytics or planning and simulation. In general, the knowledge management tools 450 can be used to configure customized collaboration scenarios. Collaborative objects can be integrated into the application logic in the same way as business objects, and the collaboration objects and business objects can be related to each other.

The portal 410 provides an entry point for, and an interface to, the services provided by the product innovation consolidation system 440. The portal 410 can be a Web portal and can be accessible through a public network. The portal 410 can provide a role-based user interface where users log in and have defined roles. A user's role determines the type of access provided and the format of the views presented. The portal 410 can be configurable at an individual level, such that the resulting user interface presents only those functions for which the user has access. The portal 410 provides runtime support for page rendering, roles, and navigation. In addition, the portal 410 includes a portal content directory for storing individual role information (e.g., idea developer) and worksets (e.g., idea evaluation).

The user interface layer 420 implements a user interface built with a model-view-controller principle, which establishes a clear separation between visualization (i.e., a view) and application logic (i.e., a model), with a mediating controller level in between. In accordance with this principle, generic user interface patterns (e.g., a tab-strip view or a list view) offer interfaces toward the model. The model provides the business data and specifies which information is transferred into which generic field of the generic user interface patterns. In addition, pre-configured templates can be provided to simplify recurring needs. The user interface layer 420 includes a user interface component repository for storing the user interface patterns and components (e.g., display idea).

In one implementation, the integrated product innovation management system 400 is a people-driven, cross-functional, composite, collaborative application. The integrated product innovation management system 400 is people-driven in that people work on specific tasks in specific roles in specific teams. The integrated product innovation management system 400 gives the right people the right information at the right time.

The integrated product innovation management system 400 is cross-functional because it runs across multiple existing applications and company boundaries and drives end-to-end business processes across heterogeneous systems. The integrated product innovation management system 400 is composite in that it orchestrates flexible business processes in synchronization with existing processes and helps leverage existing investments. Thus, the system integrates data and functional components of underlying operating systems.

Finally, the integrated product innovation management system 400 is collaborative by supporting rich information and communication throughout the enterprise between persons in different areas of responsibility (e.g., marketing, sales, and service) and/or different geographic locations. The product definition phase involves significant collaborative processes where teams, internal and external partners, etc. work together. In addition, the system includes predefined collaborative scenarios but is also adaptable to the needs of an enterprise that implements the system.

The systems and techniques described above can be implemented to manage the product innovation and definition process. The following describes one implementation of an integrated product innovation management system in an example industry using example roles. Other implementations are also possible.

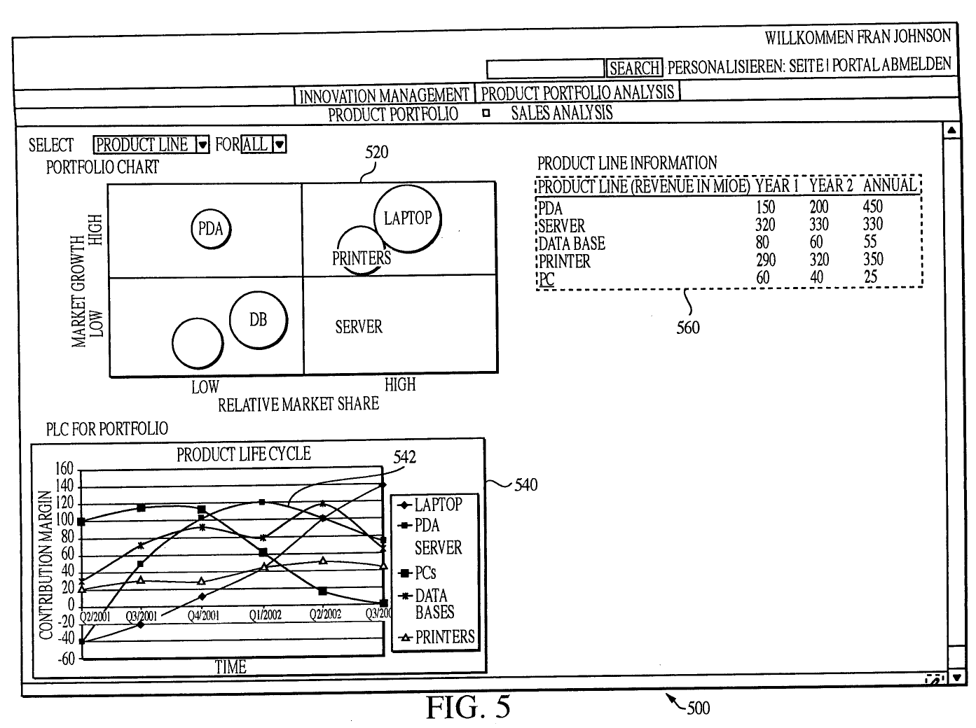

FIG. 5 shows an example view 500 created by an integrated product innovation management system. The view 500 and the other view described below can be Web pages, which may be displayed via a client 200 (see FIG. 2). These views also can be windows with associated function buttons (e.g., minimize, restore/maximize, and close buttons) and/or scroll bars. These views can be frames within windows or Web pages. In general, user's views are customized according to the role of the user. Thus, a product innovation manager will generally have a view that is different from that of a concept evaluator or an idea contributor.

The view 500 shows a presentation that has been personalized through a portal for a user (e.g., Fran Johnson) with a product innovation manager role, which is a composite role including multiple component roles. The view 500 presents a product portfolio analysis user interface that includes an example portfolio chart 520, an example product life cycle chart 540 for the portfolio, and a product line information chart 560. These charts present information from which the product innovation manager can determine which products might benefit from an innovation. For example, the example portfolio chart 520 charts the overall market growth for different product lines versus the relative market share for each product line that the enterprise markets. The example product life cycle chart 540 shows the contribution that each product line is making toward the profitability of the enterprise, and the product line information shows the revenue from each product line.

The product portfolio analysis view 500 allows the user to analyze the product portfolio on a regular basis. The data needed to generate the reports can come from a business information warehouse and from external data (e.g., from research performed outside of the enterprise) combined with internal data (e.g., from the underlying base systems).

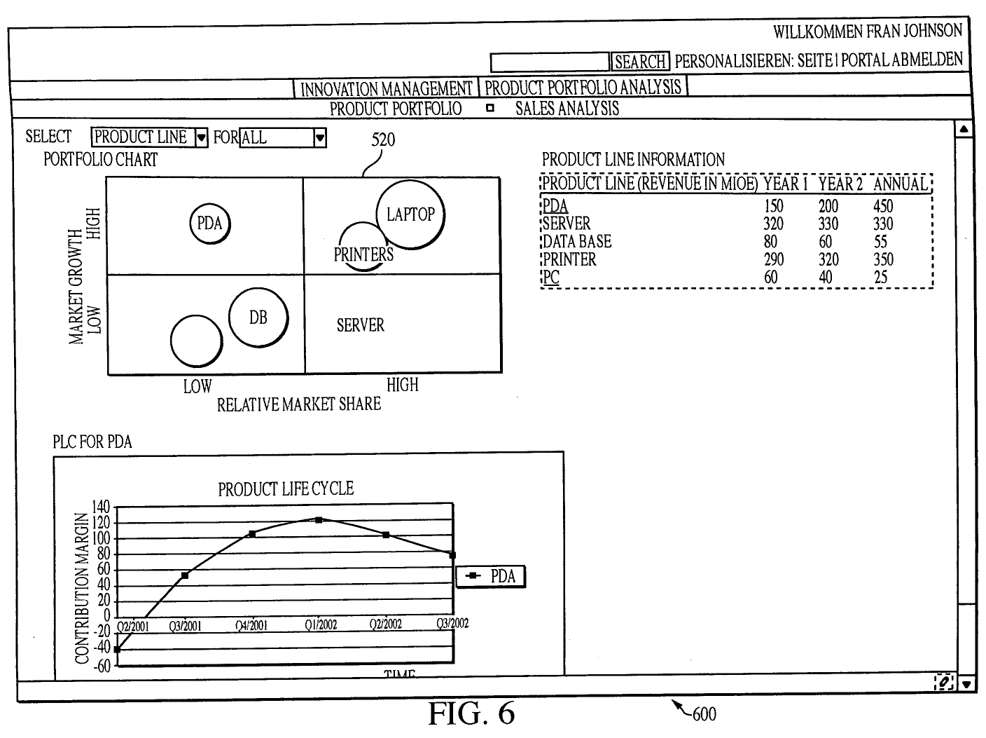

By selecting one product line within one of the charts, information from other product lines can be filtered out. For example, by clicking on the PDA element 542 of the product life cycle chart 540, the other elements of the chart are removed. FIG. 6 shows an example view 600 that is displayed when the PDA element 542 of FIG. 5 is selected. Based on the information in the view 600, the product innovation manager can determine that the product life cycle for the PDA is in decline over the last few months and that a re-launch may be appropriate. Accordingly, the product innovation manager can send a survey to colleagues in sales, service, and marketing teams to solicit ideas about new product features that would make the PDA more successful. The product innovation manager can subsequently manage the different ideas that are submitted in response to the survey.

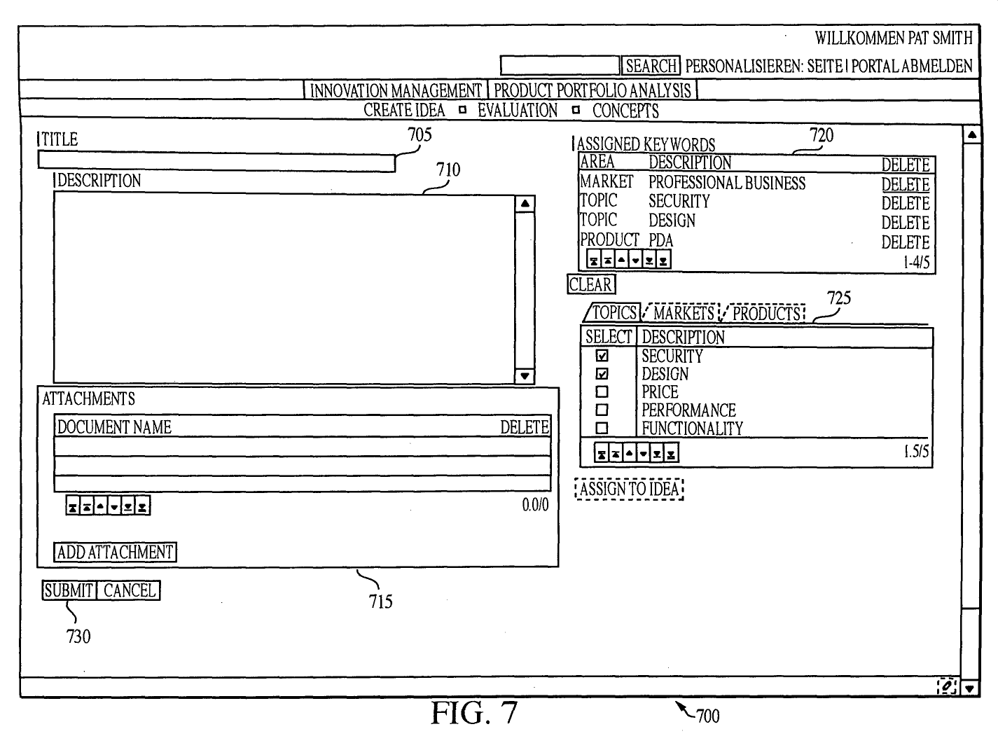

FIG. 7 shows an example idea submission view 700 created by the integrated product innovation management system. The idea submission view 700 has been personalized through the portal for a user (e.g., Pat Smith) with an idea contributor role. The idea submission view 700 includes a title field 705 for naming the idea, a description field 710 for describing the idea, and an attachment field 715 in which documents containing information relevant to the idea can be attached. The idea submission view 700 also includes an assigned keywords display 720 and a keyword selection menu 725. The keyword selection menu 725 includes a number of preselected keywords in different areas, such as topics, markets, and products. Once a keyword is selected, the keyword and its associated area are displayed in the assigned keywords display 720. The assigned keywords can be used by the integrated product innovation management system to organize and classify ideas for subsequent sorting and filtering. Once an idea is complete, the user can submit the idea by selecting a submit button 730, and the idea is placed in the idea pool.

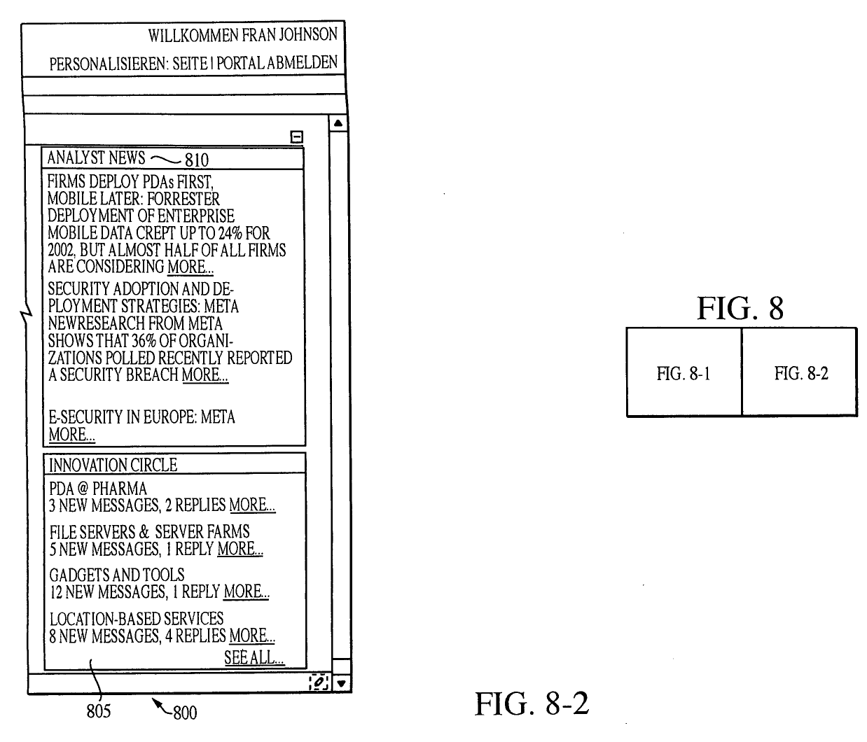

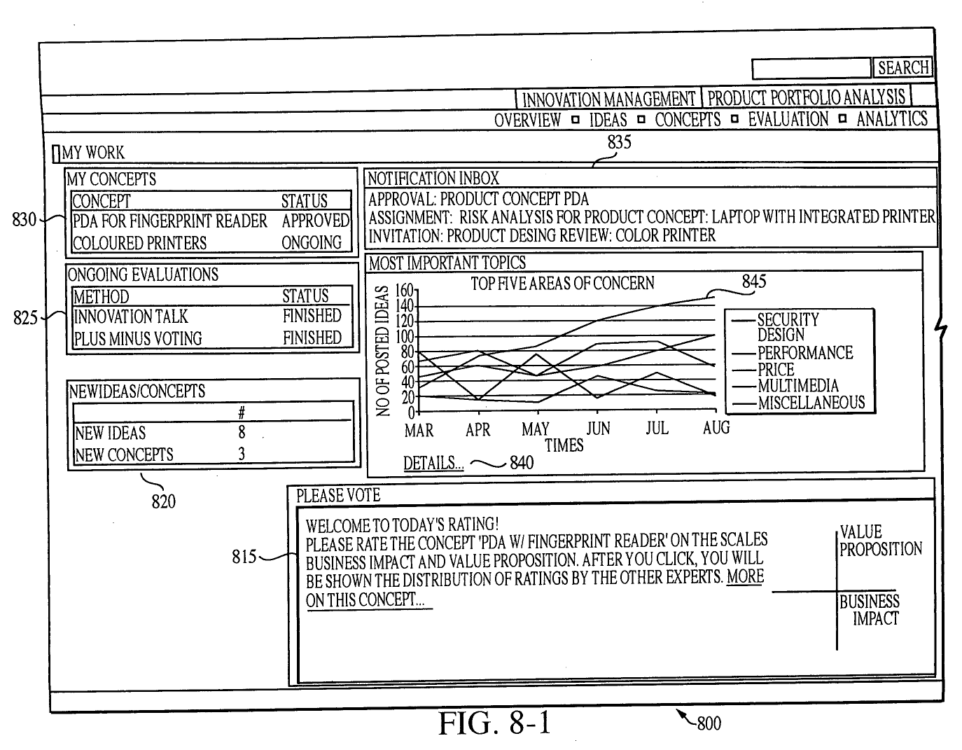

On a periodic basis, the product innovation manager can refer to an innovation management overview view 800, as shown in FIG. 8. The innovation management overview view 800 displays the different kinds of collaborative services that are available and displays information that is relevant to the product innovation process. For example, an innovation circle display 805 lists the innovation circles of which the user is currently a member. An analyst news display 810 presents a summary of articles that are selected according to the user's needs. For instance, analyst reports are filtered according to the user's knowledge management keywords. By clicking on a link, the report is displayed in a separate window.

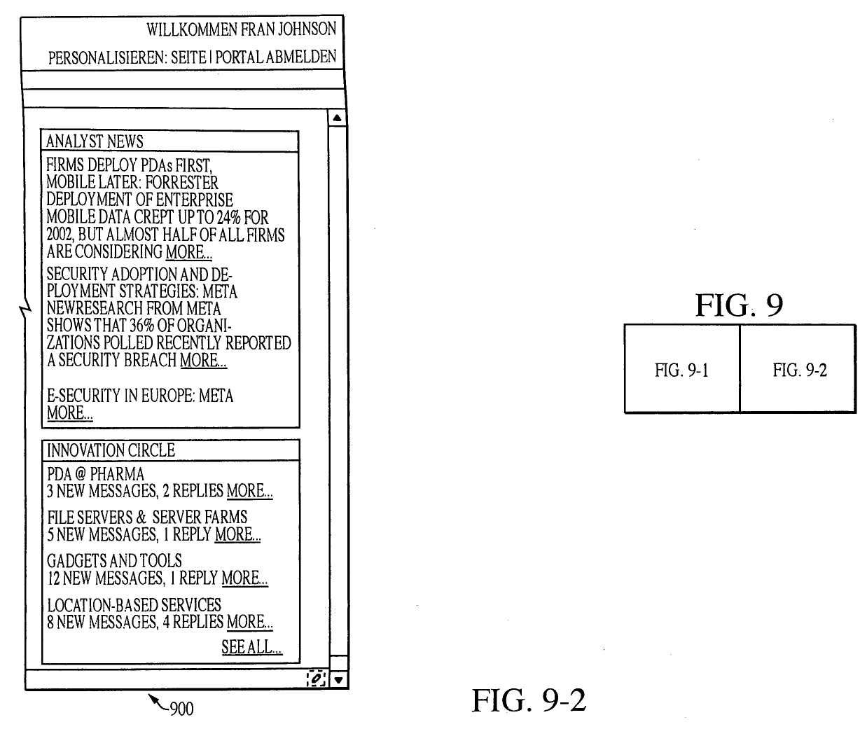

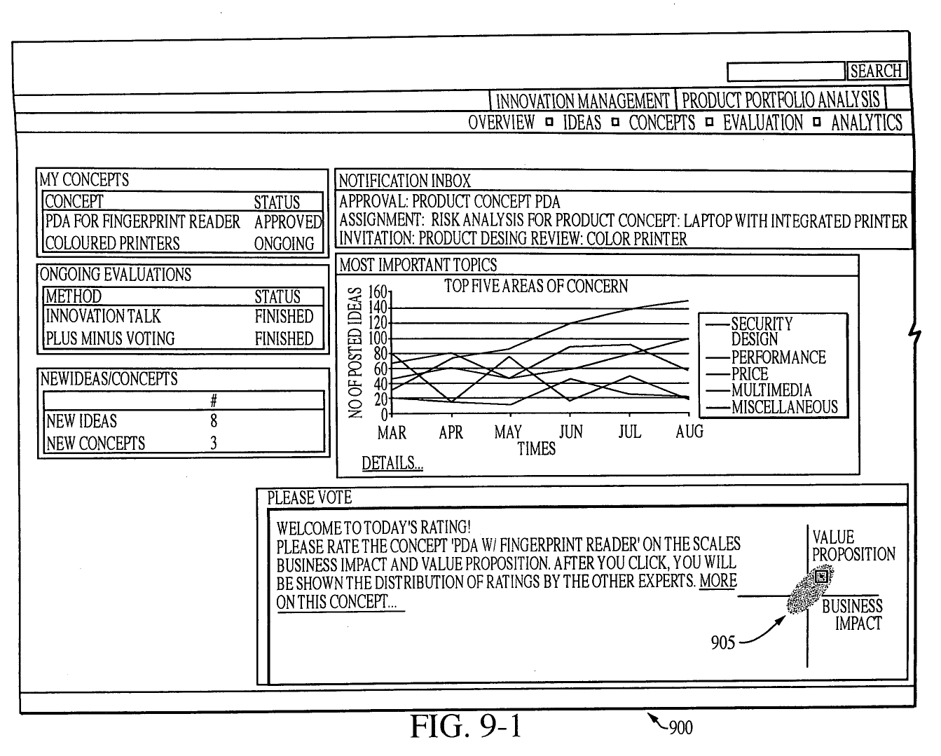

The innovation management overview view 800 also includes a voting invitation box 815 inviting the user to vote on a new concept for a PDA with a fingerprint reader. The user can click on a link for more information on the concept or can vote on the graph by designating the user's own beliefs as to the value proposition and probable business impact presented by the concept. Once the user votes, the innovation management overview view 900 is updated to display a distribution of thoughts 905 from other colleagues, as shown in FIG. 9.

The innovation management overview view 800 also includes a new ideas/concepts report 820 showing the number of new ideas and new concepts. An ongoing evaluations display 825 shows the status of ongoing evaluation projects of certain ideas or concepts. A user concepts display 830 reports on new concepts associated with projects with which the user is involved. A notification box 835 identifies items that require action by the user. A topical overview display 840 presents a graphical overview from the business information warehouse indicating the number of new ideas fro various topics by month. In this example, the user is presented with data indicating that a large number of ideas relating to security have been submitted. Accordingly, the user might deduce that security is currently of particular concern. By clicking on the security part 845 of the graph, the user may be taken to an ideas section of the integrated product innovation management system.

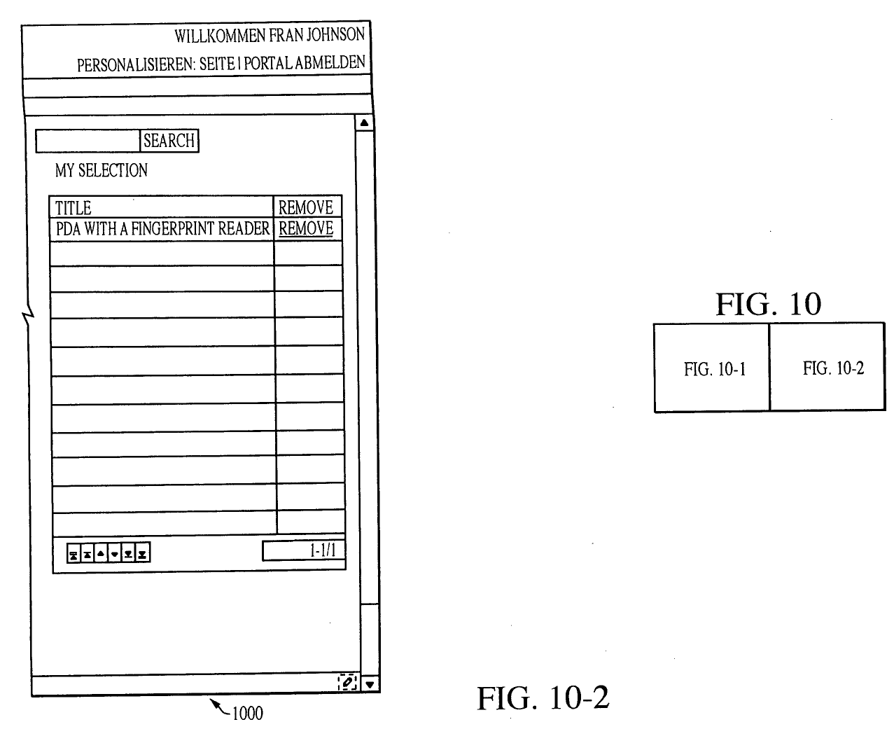

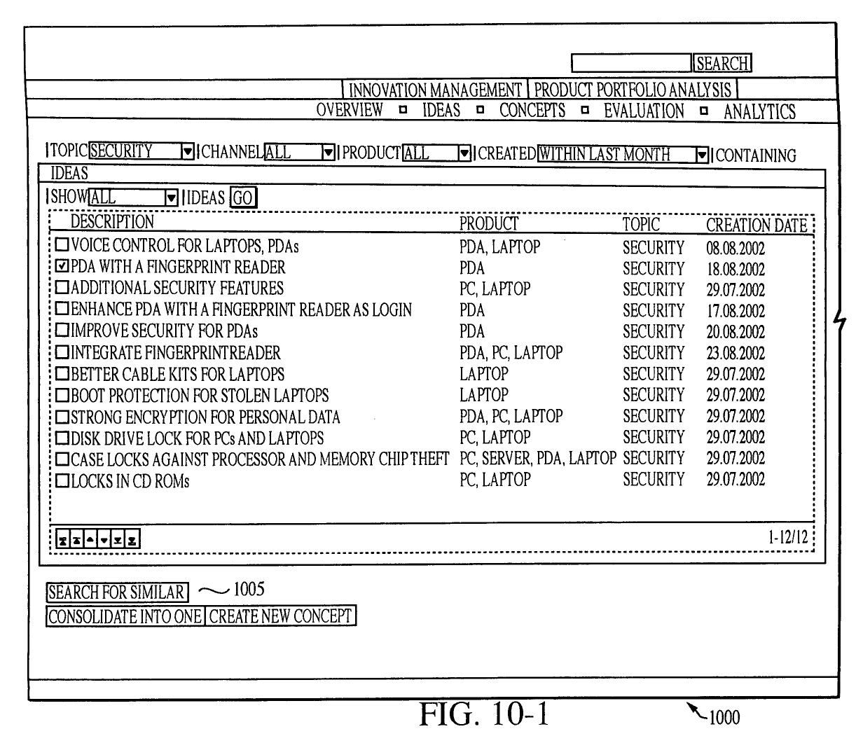

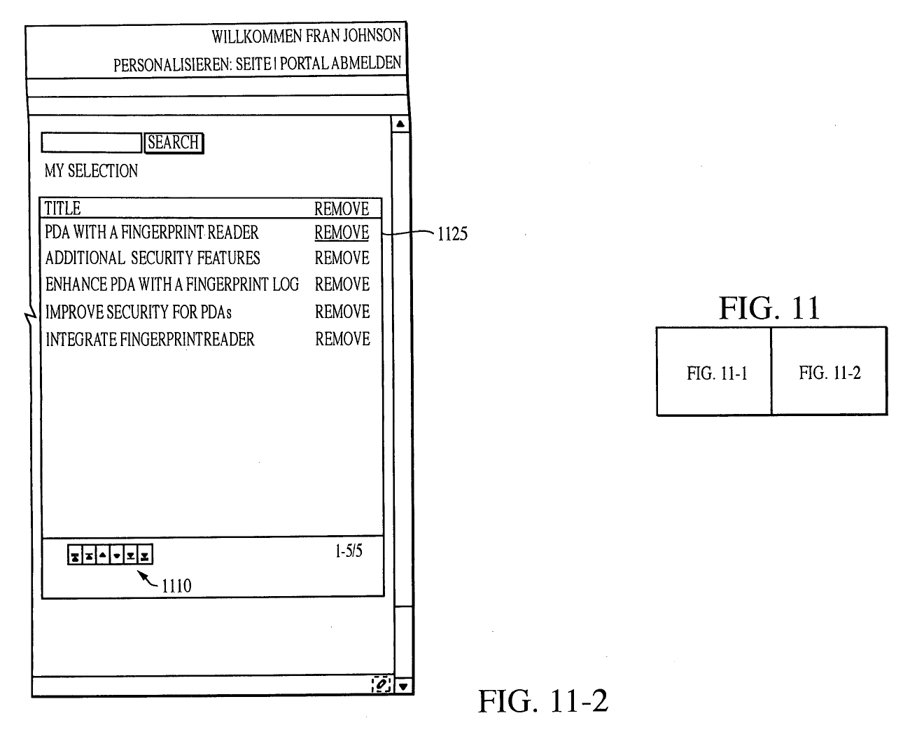

FIG. 10 shows an ideas view 1000 generated by the integrated product innovation management system. The ideas view 1000 displays the pool of ideas, which in this case are filtered according to topic. Ideas can also be filtered according to products or creation date. The user can read individual idea descriptions by clicking on the idea. The user can also select ideas that he or she likes. In this example, the user has selected the idea of a PDA with a fingerprint reader. The user can use a search and retrieval functionality to identify similar ideas by selecting a search for similar button 1005. This search can be based on keywords and/or documents attached to ideas. Similar ideas are automatically transferred to the selection section 1110, as shown in FIG. 11. The user can consolidate the selected ideas into one idea using a consolidate button 1115 and/or can create a new product concept (e.g., for a new PDA) incorporating the selected set of ideas by selecting a create new concept button 1120. In addition, the user can remove ideas from the selection section 1110 using a remove link 1125. By creating a new product concept, all of the ideas, documents, and descriptions associated with the selected ideas are transferred to a new concept.

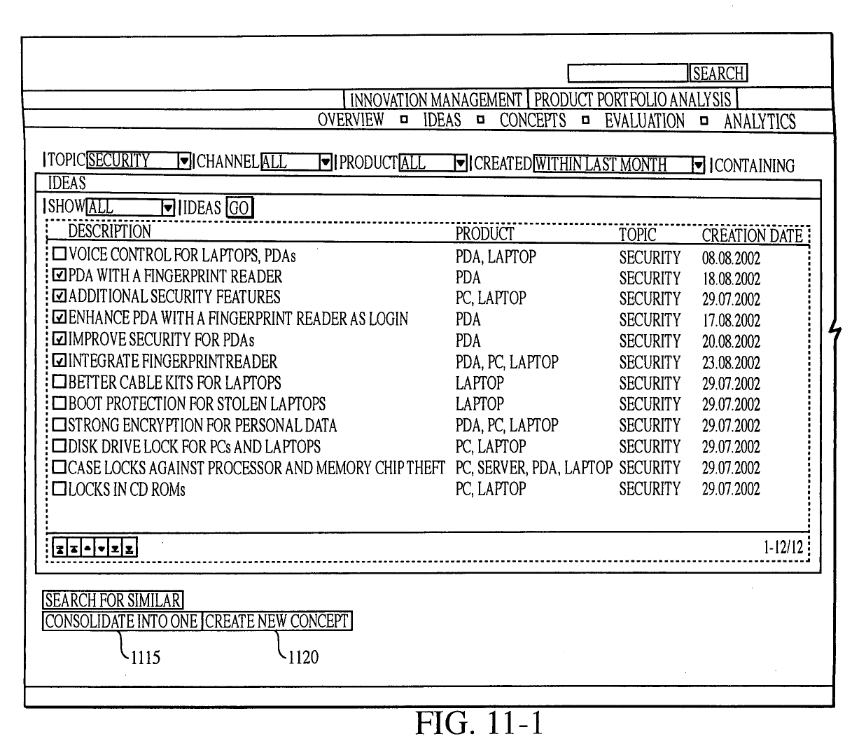

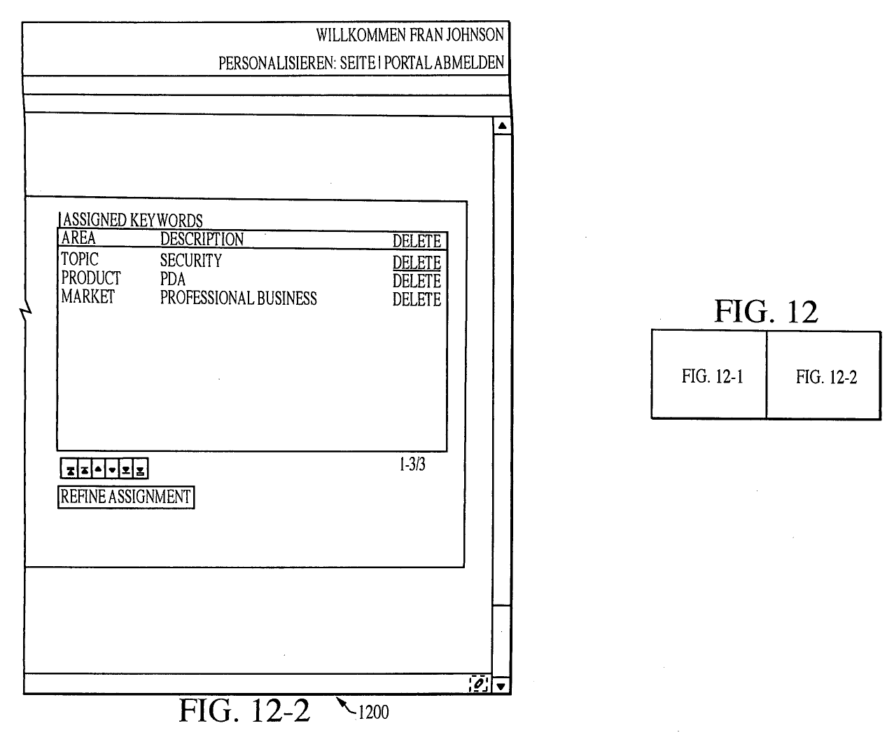

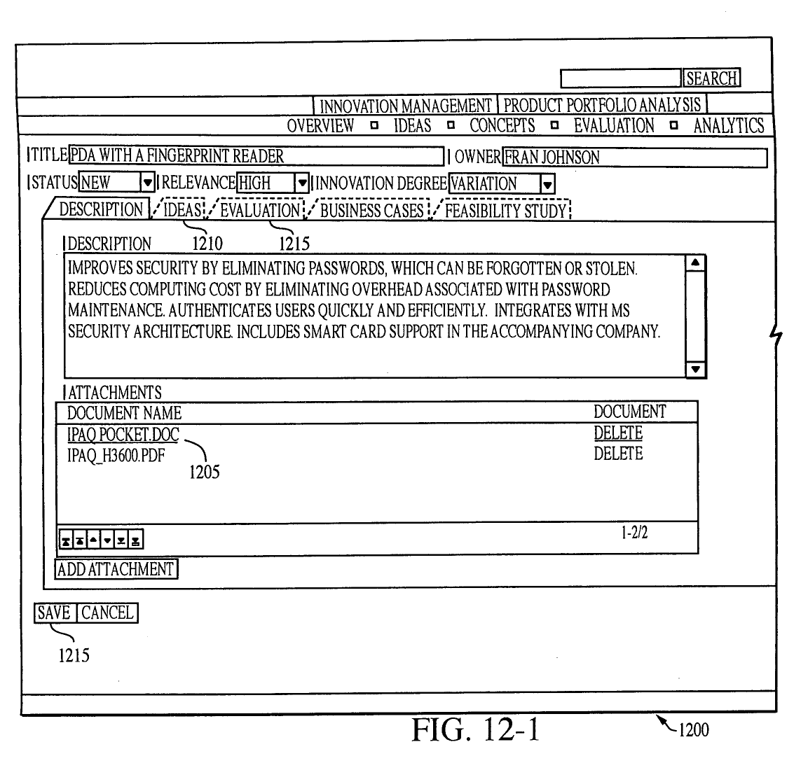

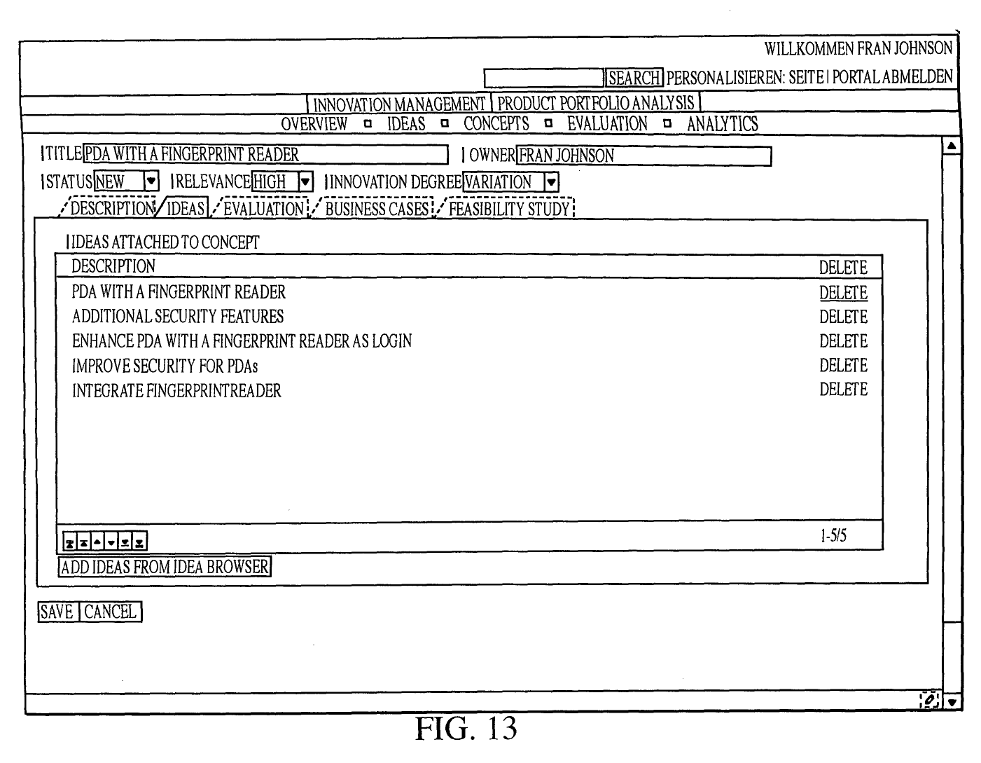

FIG. 12 shows a concept view 1200 generated by the integrated product innovation management system. The concept contains keywords, which are the consolidated keywords from the ideas the went into the concept. The description and title of the concept are taken from the first idea that went into the concept. The user, however, can refine the description, title, and the assignment of keywords and can insert documents into the document list 1205. In addition, the user can select an idea tab 1210 and re-enter the idea pool to search for further ideas (e.g., design features unrelated to security) for the planned PDA re-launch (see FIG. 13). Once the user is finished modifying the concept, the user can save the concept by selecting a save button 1215, which creates a new concept object within the integrated product innovation management system. Once a new concept is created, the user can initiate an evaluation of the concept by selecting an evaluation tab 1220.

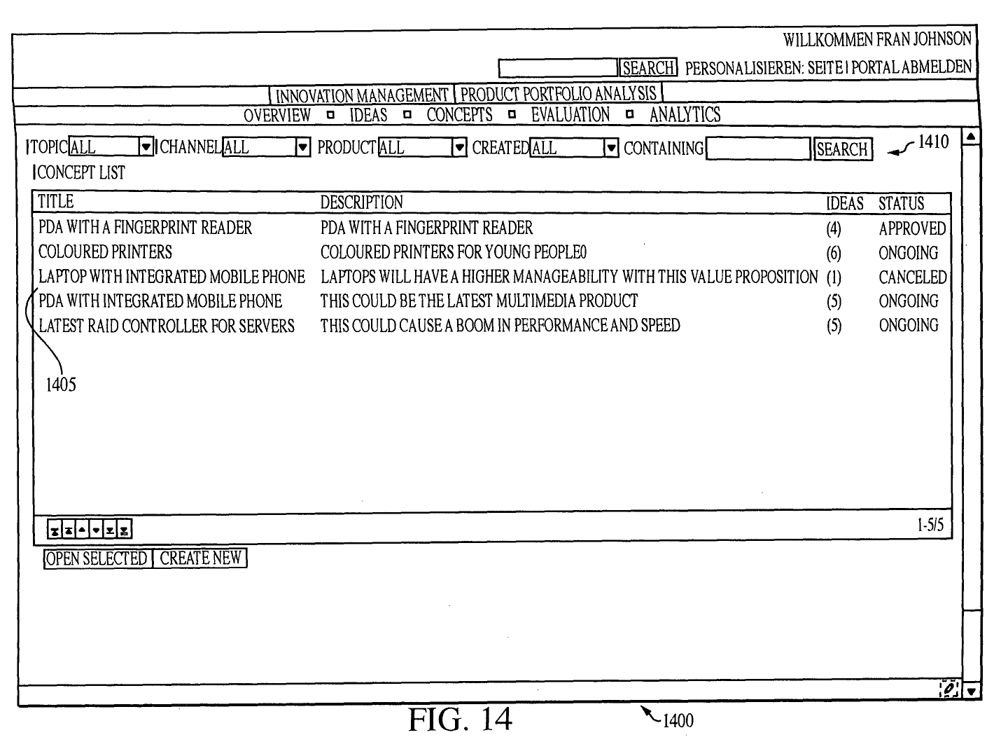

A user can also view a list of all concepts and/or all concepts with which the user is involved. FIG. 14 shows a concept list view 1400 that includes a list 1405 of concept objects in the integrated product innovation management system. A user can filter the concepts listed according to certain criteria selections 1410. If the user selects a particular concept, more detailed information about the selected concept is then displayed (see, e.g., FIG. 12).

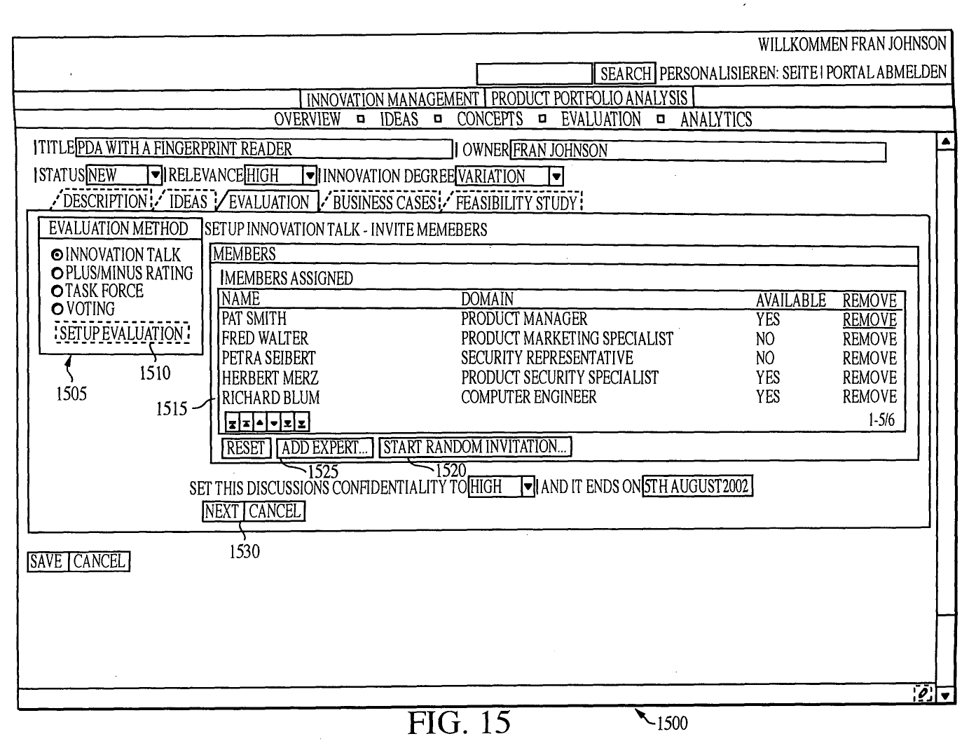

FIG. 15 shows an evaluation setup view 1500 generated by the integrated product innovation management system. In the evaluation setup view 1500, different collaborative services, such as an innovation talk, a plus/minus rating, a task force, and voting, are provided by the knowledge management system. The user can select a collaborative evaluation method from an evaluation method list 1505 and setup a corresponding evaluation by selecting a setup evaluation button 1510. The integrated product innovation management system provides different suggestions for possible participants whose names are inserted into a team member list 1515. The suggestions can be generated by integrating data from a human resources management system. For example, keywords that characterize the concept can be matched against the skill set of employees stored within the human resources management system. The user can also search for other experts or solicit input from others by random selection using a random invitation button 1520 or by selective invitation using an add expert button 1525. Once the participants are assigned, the user can further define the evaluation (e.g., the innovation talk) using a next button 1530.

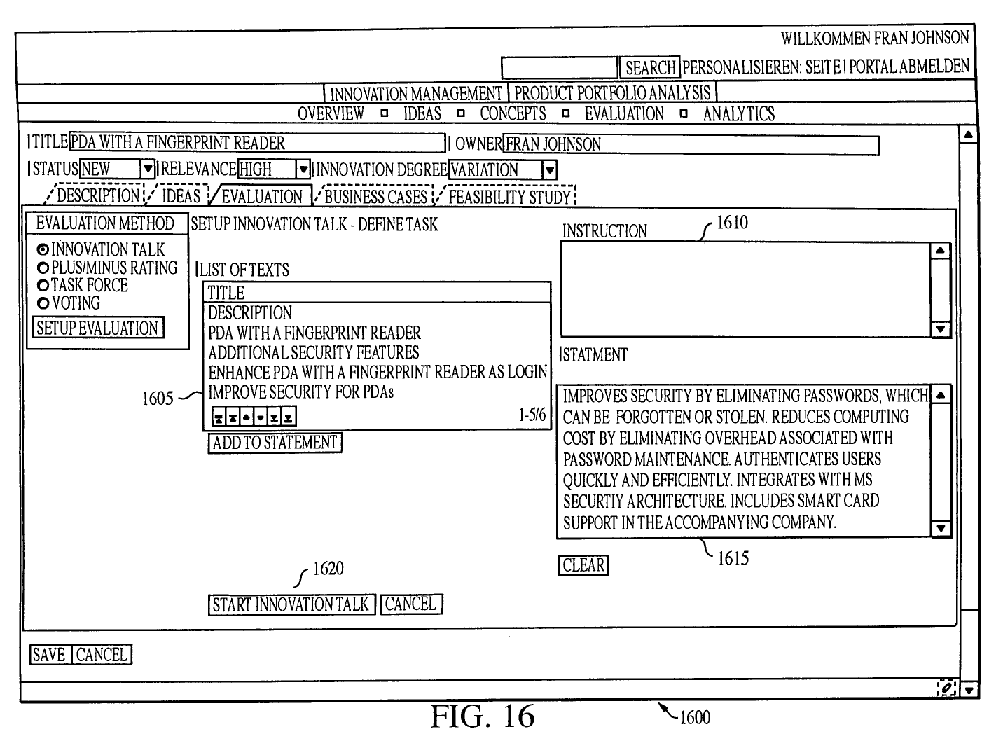

FIG. 16 shows an innovation talk setup view 1600 generated by the integrated product innovation management system. The innovation talk setup view 1600 includes a list of texts 1605 associated with the evaluation, a set of instructions (if necessary) 1610, and a statement 1615 representing, for example, a description of the concept or any underlying ideas. Once the innovation talk setup information is complete, the user can initiate the evaluation by selecting a start innovation talk button 1620. Members of the innovation talk are then notified in their own overview display (similar to that of FIG. 8) that they have a pending evaluation assignment.

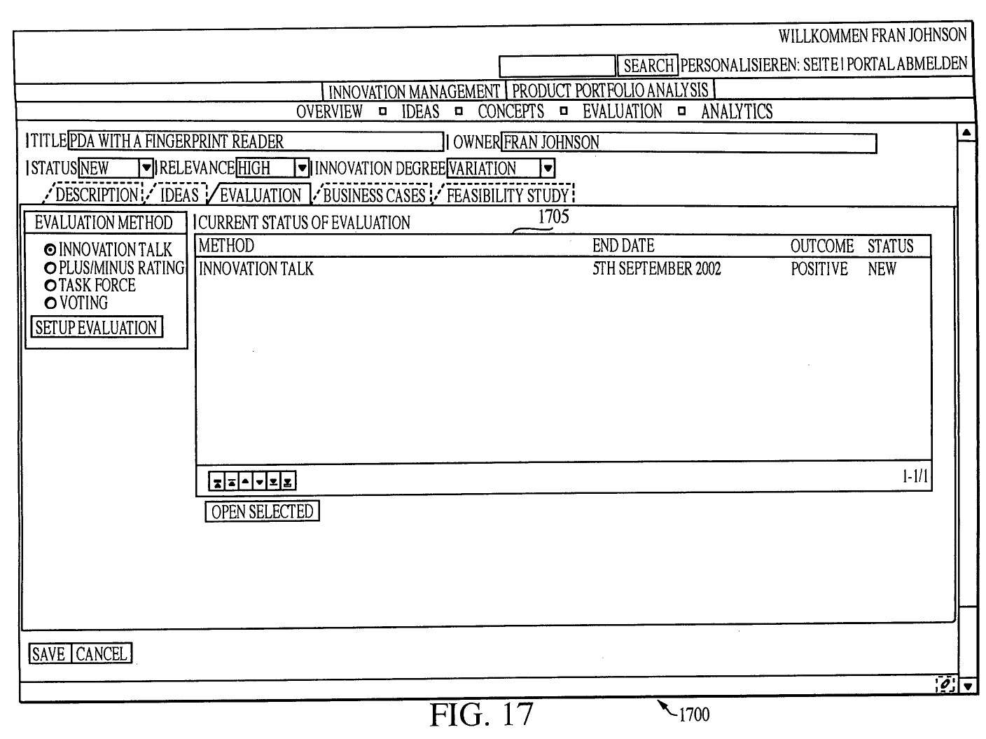

FIG. 17 shows an evaluation status view 1700 generated by the integrated product innovation management system. The evaluation status view displays the evaluation status 1705 of the different types of evaluations for the selected concept. In this case, the evaluation status 1705 indicates that an innovation talk is underway.

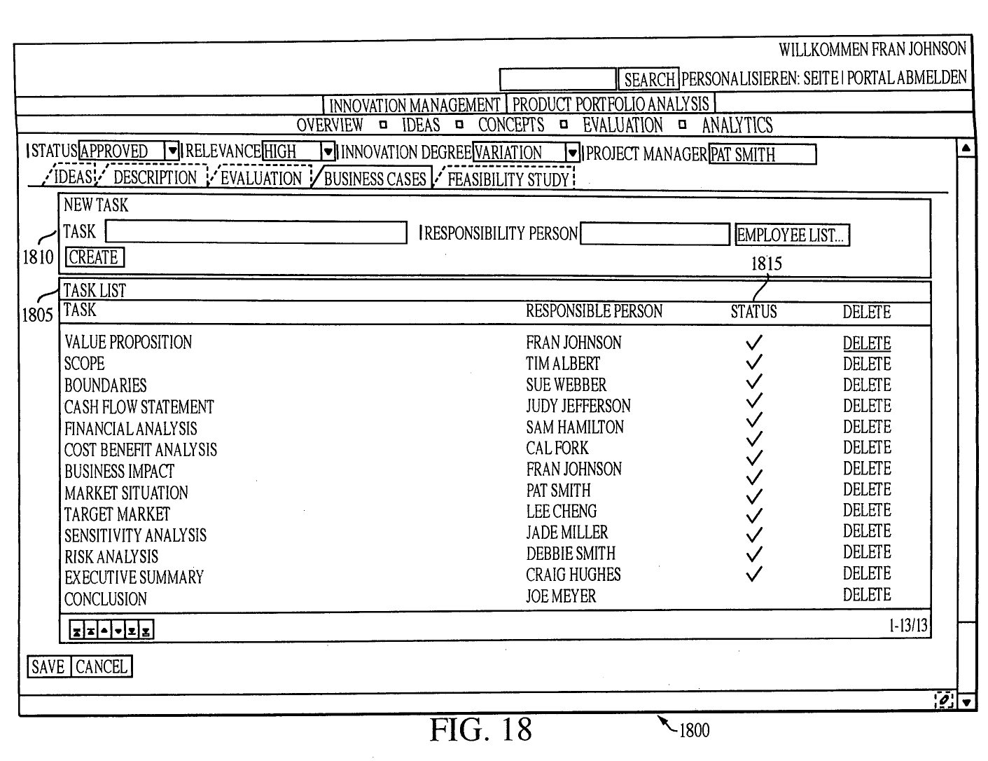

At some point during the collaborative product definition process (e.g., once a concept is approved during the evaluation stage), a product innovation manager can initiate a business case study and/or a feasibility study. FIG. 18 shows a business case study view 1800. The business case study can be organized as a task list 1805 with tasks assigned to appropriate persons or teams. The integrated product innovation management system can suggest tasks based on data regarding prior business case studies and/or can suggest appropriate persons to perform tasks based on data from the human resources management system. The user can also create new tasks and assign responsible persons using a new task display 1810. Once tasks are assigned, the person or persons to which each task is assigned can be notified in a notification box 835 of their own innovation management overview view 800 (see FIG. 8), which will be customized depending on the assigned person's role in the innovation management process. The assigned person can access information about the concept, including the description and any necessary information from prior tasks that have been performed and/or from underlying base systems, via the product innovation management system. The assigned person can then complete the task and provide any necessary feedback or other information via the product innovation management system. An indication that the task is complete can be displayed in a task status field 1815 of the business case study view 1800.

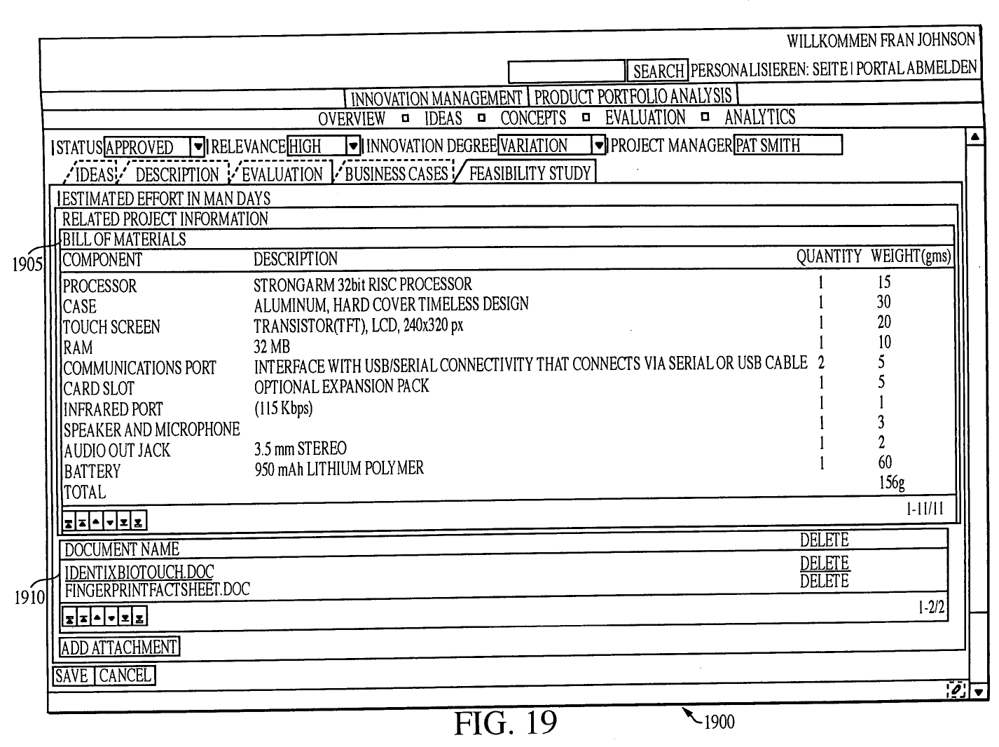

FIG. 19 shows a feasibility study view 1900 generated by the integrated product innovation management system. The feasibility study data is derived from the underlying systems, such as a product lifecycle management system, and can include, for example, a bill of materials 1905 from a predecessor PDA. Documents relating to the technical aspects of implementing the concept can also be attached in an attached document area 1910.

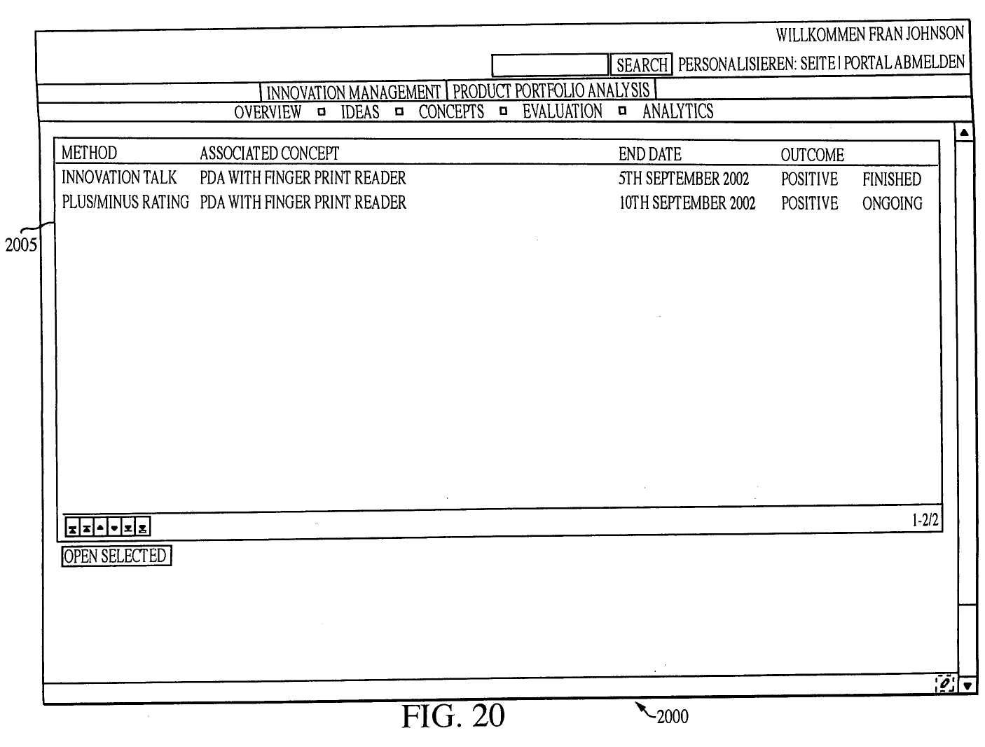

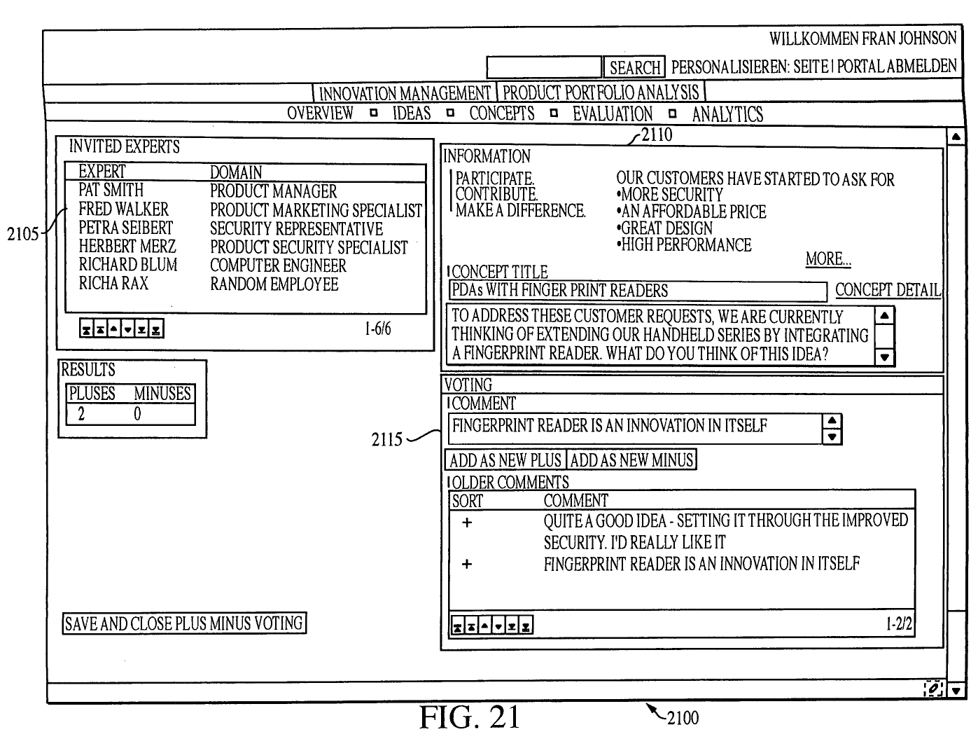

Once the business case and feasibility studies are complete, further evaluation of the concept can be initiated. In one implementation, for example, further evaluation can occur at predefined quality gates. FIG. 20 shows an evaluation status view 2000 similar to that of FIG. 17. In this case, the innovation talk is complete, but a new plus/minus rating evaluation has begun as indicated in the evaluation status display 2005. FIG. 21 shows a plus/minus voting evaluation view 2100 that includes an invited expert list 2105, an information display 2110 for information on the concept, and a voting display 2115 for adding and displaying votes and comments. Assuming the concept is finally approved, the entire design process starts. In one implementation, all of the information assembled during the product definition stage (e.g., from the business case and feasibility studies) can be accessed during the design process.

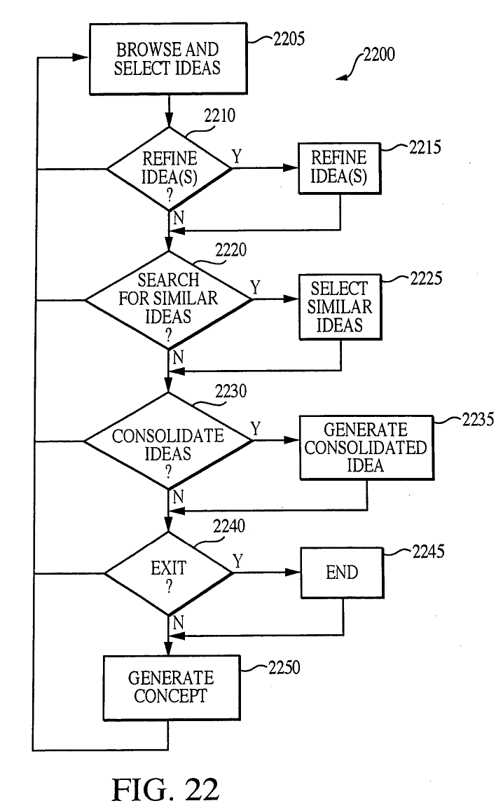

FIG. 22 is a flow diagram illustrating a concept generation process 2200. A user can browse a list of ideas submitted by others and can select ideas that are of interest (step 2205). The user can then determine whether to refine the selected idea(s) (steps 2210 and 2215), to search and select similar ideas (steps 2220 and 2225), and/or consolidate different ideas into a single idea entry (steps 2230 and 2235). Once the user has completed any idea refinement, searching and selecting of similar ideas, and /or consolidation of ideas, the user can determine (step 2240) whether to exit to process 2200 (step 2245) or to generate a concept based on the selected idea(s) (step 2250). If a concept is generated, the user can determine (step 2255) whether to initiate a product definition process based on the draft concept from step 2250. In addition, at virtually any time during the process 2200, the user can return to browsing and selecting ideas (step 2205).

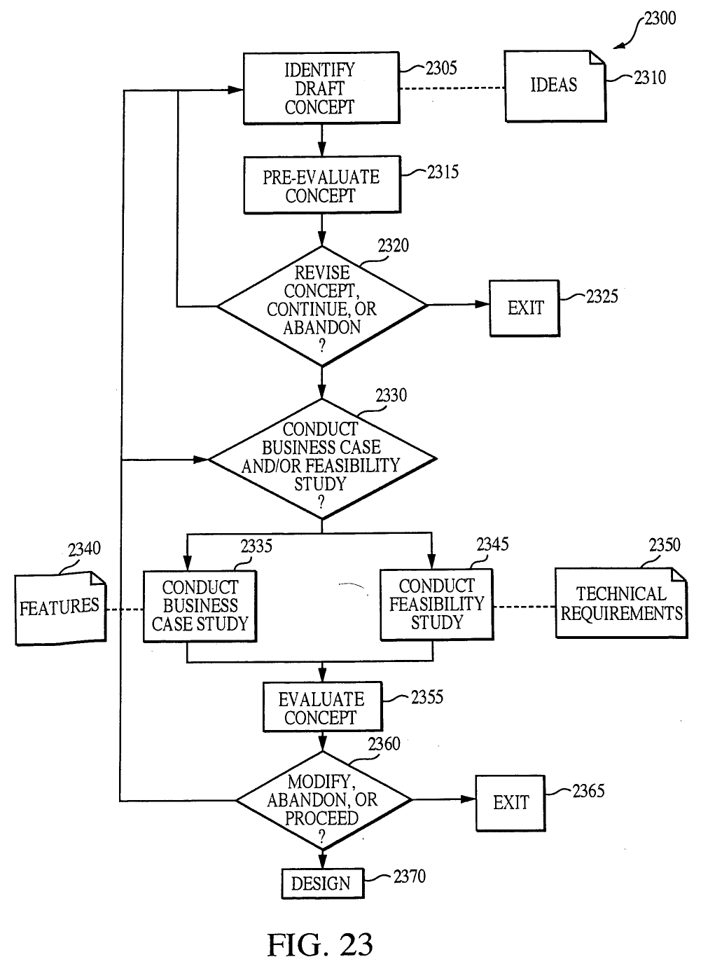

FIG. 23 is a flow diagram illustrating a product definition process 2300. The process begins with a draft concept (step 2305) that is the result of one or more ideas 2310 that may have been combined, consolidated, and/or refined. The draft concept is subjected to a pre-evaluation in which two or more team members collaborate to evaluate the concept (step 2315). Next, a decision is made based on the results of the pre-evaluation (step 2320). For example, the process 2300 can end if the team members decide that the concept should be abandoned (step 2325), or the team members can decide that the draft concept should be modified in some way by returning to step 2305. Alternatively, if the team members decide that the draft concept should be further investigated and developed, a decision is made (step 2330) as to whether to conduct a business case study (step 2335), in which the features 2340 of the product are further defined, and/or to conduct a feasibility study (step 2345), in which the technical requirements 2350 of the concept are identified.

An evaluation is performed based on the outcome of the business case study and/or the feasibility study (step 2355), and a decision is made (step 2360) regarding whether to abandon the concept (step 2365), to modify the concept by returning to step 2305, to modify the business case and/or feasibility studies by returning to step 2330, or to proceed with implementing the concept by moving into a product design phase (step 2370).

In general, the product innovation management system facilitates the definition and evaluation of new product ideas using consolidated idea pools to identify promising product innovations and workflows for the development of iterative business case and feasibility studies. Collaborative services provide for team-based review of product innovations. Quality gates enable a step-by-step approval of new product concepts, and product portfolio and market trend analyses tools provide guidance and context for concept development and evaluation.

By improving the ability to effectively and efficiently develop innovations, product innovation management system helps set up new revenue potential. The system increases input during the idea generation phase by encouraging stakeholders to contribute product ideas, using the speed and reach of web-based technologies to collect ideas, exploiting existing information sources for input collection, and ensuring reliable feedback for participants. The system allows users to access and evaluate a consistent set of ideas by homogenously storing and classifying ideas and requirements, permitting holistic analysis of the idea pool, and managing the requirement evaluation process with minimal overhead. Moreover, the system provides control to a process driven by emotions by revealing and managing criteria for decision points, accelerating decision making, establishing and auditing priorities, and tracing ideas and requirements throughout the product life cycle.

Various implementations of the systems and techniques described here can be realized in digital electronic circuitry, integrated circuitry, specially designed ASICs (application specific integrated circuits), computer hardware, firmware, software, and/or combinations thereof. These various implementations can include one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) may include machine instructions for a programmable processor, and can be implemented in a high-level procedural and/or object-oriented programming language, and/or in assembly/machine language. As used herein, the term “machine-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back-end component (e.g., as a data server), or that includes a middleware component (e.g., an application server), or that includes a front-end component (e.g., a client computer having a graphical user interface or a Web browser through which a user can interact with an implementation of the systems and techniques described here), or any combination of such back-end, middleware, or front-end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

Although only a few embodiments have been described in detail above, other modifications are possible. Portions of this disclosure discuss the use of a collaborative web-based product innovation system although the techniques and systems can be used to provide controlled, collaborative processes for virtually any business activity. The logic flows depicted in FIGS. 3, 22, and 23 do not require the particular order shown, or sequential order, to achieve desirable results. For example, the solicitation and review of ideas and the combination or consolidation of new ideas into a new or existing concept may be performed at many different places within the overall process. In certain implementations, multitasking and parallel processing may be preferable.

Other embodiments may be within the scope of the following claims.

What is claimed is:

1. A method for facilitating collaborative development of product definitions, the method comprising:
presenting a plurality of product innovation ideas for review by a user;
receiving an indication of at least one user-selected product innovation idea; and
supporting web-based collaboration among an evaluation team comprising a plurality of members for evaluating the at least one user-selected product innovation idea.

2. The method of claim 1 further comprising:
receiving the plurality of product innovation ideas via a network; and
storing the product innovation ideas.

3. The method of claim 1 further comprising further comprising:
presenting information for setting up a business case study relating to the at least one user-selected product innovation idea; and
receiving data relating to assigned tasks for the business case study; and
providing access to the data relating to the assigned tasks.

4. The method of claim 1 further comprising:
presenting information for conducting a feasibility study relating to the at least one user-selected product innovation idea;
retrieving data relating to a previously developed product corresponding to the product innovation idea, wherein the data relating to the previously developed product is retrieved from a product management system; and
updating the information for conducting the feasibility study based on the retrieved data.

5. The method of claim 1 wherein the evaluation team evaluates the at least one user-selected product innovation idea after performing at least one of a business case study and a feasibility study.

6. The method of claim 1 further comprising:
receiving evaluation information from at least one of the members of the evaluation team;
storing the evaluation information; and
providing access to the stored evaluation information to other members of the evaluation team.

7. The method of claim 6 further comprising receiving data for modifying the at least one user-selected product innovation idea from the user based on the evaluation information.

8. The method of claim 1 further comprising allowing the user to perform at least one action selected from the group consisting of modifying the at least one product innovation idea, searching for similar ideas, and consolidating a selected collection of ideas into a single idea.

9. The method of claim 1 further comprising automatically generating a list of suggested members for the evaluation team based on a correspondence between data associated with the at least one user-selected idea and data from a human resources system.

10. The method of claim 1 further comprising:
displaying at least one of product portfolio performance data and product market data to the user from which the user can identify products that may benefit from a product innovation; and
receiving information from the user for soliciting product innovation ideas, wherein the received product innovation ideas are responsive to the information for soliciting product innovation ideas.

11. A product innovation management system, the system comprising:
a computer system;
a product innovation consolidation system stored within the computer system and accessible via a network, the product innovation consolidation system comprising:
a business object layer operable to maintain objects relating to a product innovation management process;
an application services layer including logic for controlling the product innovation management process; and
a database for storing data defining instances of the objects, wherein the data relates to product innovation ideas; and
a plurality of clients operable to access the product innovation consolidation system via the network, wherein the product innovation consolidation system is operable to allow a client user to view product innovation ideas, select product innovation ideas, and initiate a collaborative evaluation of selected product innovation ideas.

12. The product innovation management system of claim 11 further comprising knowledge management tools for supporting the product innovation management process, wherein the knowledge management tools provide services selected from the group consisting of document services, collaboration services, and search and retrieval services.

13. The product innovation management system of claim 12 further comprising an interface to at least one base system from which the product innovation consolidation system can retrieve data relating to at least one of products, financials, projects, resources, customers, suppliers, schedules, and individuals.

14. The product innovation management system of claim 13 wherein the product innovation consolidation system further comprises an access layer for coordinating access between the application services layer, the knowledge management tools, and the at least one base system.

15. The product innovation management system of claim 11 wherein the client user can access the product management consolidation system to view at least one of performance data for a product portfolio and product market data and to solicit product innovation ideas from other client users.

16. The product innovation management system of claim 11 wherein the client user can access the product management consolidation system to identify an evaluation team comprising a plurality of members.

17. The product innovation management system of claim 16 wherein suggestions for the evaluation team members are automatically generated by the product management consolidation system based on a correspondence between parameters of at least one selected product innovation idea and a skill set of each evaluation team member.

18. The product innovation management system of claim 16 wherein the evaluation team members can access the product innovation consolidation system to provide feedback relating to at least one selected product innovation idea.

19. A machine-readable medium storing instructions operable to cause one or more machines to perform operations comprising:
receiving product innovation ideas;
displaying received product innovation ideas to a user;
receiving a selection from the user of at least one product innovation idea to generate a product concept;
providing information relating to the product concept to an evaluation team comprising a plurality of members;
receiving feedback relating to the product concept from members of the evaluation team; and
displaying the feedback to the user.

20. The machine-readable medium of claim 19 further comprising instructions operable to cause one or more machines to receive data for modifying the product concept.

21. The machine-readable medium of claim 19 wherein the feedback includes at least one of requirements for the product concept, features of the product concept, comments on the product concept, and ratings of the product concept.

22. The machine-readable medium of claim 19 further comprising instructions operable to cause one or more machines to:
display product innovation ideas that relate to the product concept;
receive a selection of at least one of the displayed product innovation ideas that relate to the product concept; and
combine the at least one selected product innovation idea into the product concept.

23. The machine-readable medium of claim 19 further comprising instructions operable to cause one or more machines to maintain status information for an evaluation performed by the evaluation team.
